(19) United States
(12) Patent Application Publication
(10) Pub. No.: US 2026/0249787 A1
(43) Pub. Date: Aug. 27, 2026

(54) STORAGE MODULES FOR USE ON VEHICLE SEATS

(71) Applicant: Toyota Motor Engineering & Manufacturing North America, Inc., Plano, TX (US)

(72) Inventors: Haley L. Grantham, Saline, MI (US); Timothy J. Woychowski, Howell, MI (US); Aaron B. Steinhilb, Milan, MI (US); Troy N. Grantham, Saline, MI (US); Jennifer L. Pelky, Brighton, MI (US); Jeremiah T. Hammer, Ann Arbor, MI (US)

(73) Assignees: Toyota Motor Engineering & Manufacturing North America, Inc., Plano, TX (US); Toyota Jidosha Kabushiki Kaisha, Aichi-Ken (JP)

(21) Appl. No.: 19/060,562

(22) Filed: Feb. 21, 2025

(51) Int. Cl. B60R 7/04; B60R 11/00

(52) U.S. Cl. CPC B60R 7/043; B60R 11/00; B60R 2011/0012; B60R 2011/0059; B60R 2011/0071

(57) ABSTRACT

A storage module for a vehicle includes a base configured to be disposed on a seat of the vehicle. The base has an upper surface facing away from the seat and configured to support an object thereon. The storage module includes an attachment interface positioned along the upper surface for securing the object to the base and a strap coupled to, and extending from, the base. The storage module includes a coupler mounted to the strap. The coupler is configured to connect with a latch mounted to the vehicle for securing the base to the seat through the strap.

### TECHNICAL FIELD

The present specification generally relates to storages modules for vehicles and, more specifically, storage modules for use on seats of vehicles.

### BACKGROUND

The use of vehicles on off-road trails is a hobby for many vehicle operators. The vehicle operators often use storage systems that are rigidly connected to the vehicle to ensure they stay attached while driving over rough surfaces or obstacles. The storage systems are used to prevent objects stored therein from shifting while the vehicle travels. Common storage systems utilize attachments located within a truck bed or on a roof of the vehicle. However, a vehicle operator may desire to utilize a storage system within the interior of the vehicle for theft protection, weather and climate protection, accessibility while operating the vehicle, etc.

Accordingly, a need exists for storage modules for use on seats of vehicles.

In one embodiment, a storage module for a vehicle may include a base configured to be disposed on a seat of the vehicle. The base may have an upper surface facing away from the seat and configured to support an object thereon. The storage module may include an attachment interface positioned along the upper surface for securing the object to the base and a strap coupled to, and extending from, the base. The storage module may include a coupler mounted to the strap. The coupler may be configured to connect with a latch mounted to the vehicle for securing the base to the seat through the strap.

In another embodiment, a vehicle may include a chassis, a seat coupled to the chassis, a latch coupled to the chassis, and a storage module. The storage module may include a base disposed on the seat. The base may have an upper surface facing away from the seat and configured to support an object thereon. The storage module may include an attachment interface positioned along the upper surface for securing the object to the base and a strap coupled to, and extending from, the base. The storage module may include a coupler mounted to the strap and configured to connect with the latch for securing the base to the seat through the strap.

In yet another embodiment, a storage module for a vehicle may include a base configured to be disposed on a seat of the vehicle. The base may have an upper surface facing away from the seat and configured to support an object thereon. The storage module may include an attachment interface positioned along the upper surface for securing the object to the base, a rod fixed to the base, and a strap mounted to the rod and configured to secure the base to the seat.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle having a seat and a storage module, according to one or more embodiments shown and described herein;

FIG. 2 schematically depicts a perspective view of the vehicle having the seat and another embodiment of the storage module, according to one or more embodiments shown and described herein;

FIG. 3 schematically depicts a bottom plan view of another embodiment of the storage module, the storage module including a base a plurality of rods, according to one or more embodiments shown and described herein;

FIG. 4 schematically depicts a perspective view of a portion of the storage module of FIG. 3, showing the rod having a cover and an opening, according to one or more embodiments shown and described herein;

FIG. 5A schematically depicts a top plan view of another embodiment of the storage module, showing a configuration of another attachment interface, according to one or more embodiments shown and described herein;

FIGS. 5B schematically depicts a top plan view of another embodiment of the storage module, showing a configuration of another attachment interface, according to one or more embodiments shown and described herein;

FIG. 5C schematically depicts a top plan view of another embodiment of the storage module, showing a configuration of another attachment interface, according to one or more embodiments shown and described herein;

FIG. 5D schematically depicts a top plan view of another embodiment of the storage module, showing a configuration of another attachment interface, according to one or more embodiments shown and described herein;

FIG. 6 schematically depicts a top plan view of another embodiment of the storage module, including a second storage module and a third storage module, according to one or more embodiments shown and described herein;

FIG. 7 schematically depicts a top plan view of another embodiment of the storage module, showing a leg extending from the base, according to one or more embodiments shown and described herein; and

FIG. 8 schematically depicts a perspective view of a vehicle having a seat and another storage module, according to one or more embodiments shown and described herein.

### DETAILED DESCRIPTION

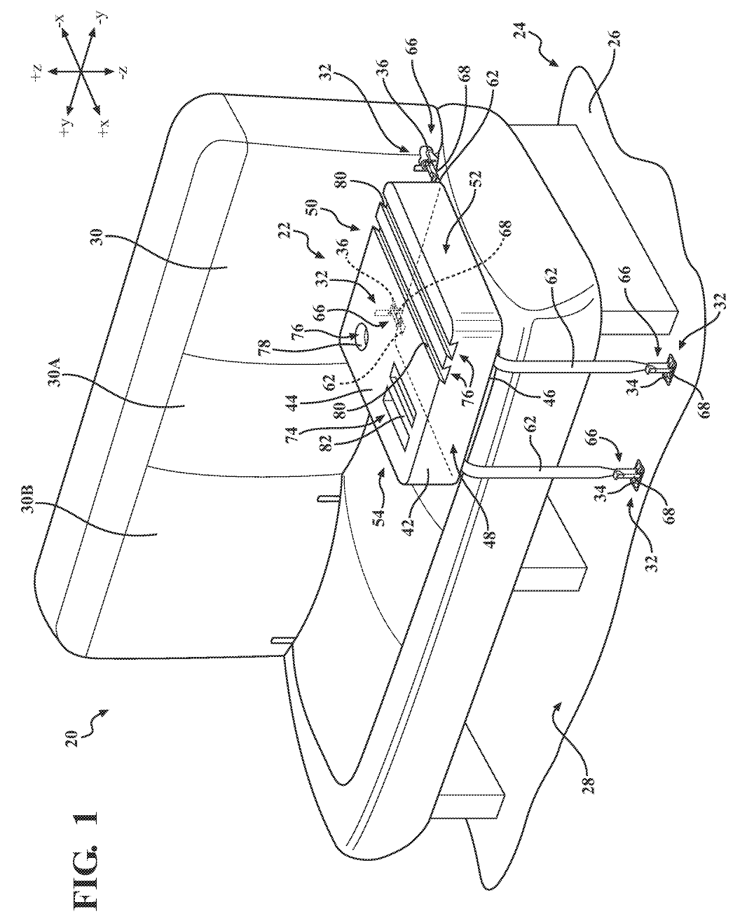

FIG. 1 generally depicts a storage module for a vehicle. The storage module may include a base configured to be disposed on a seat of the vehicle. The base may have an upper surface facing away from the seat and configured to support an object thereon. The storage module may include an attachment interface positioned along the upper surface for securing the object to the base and a strap coupled to, and extending from, the base. The storage module may include a coupler mounted to the strap. The coupler may be configured to connect with a latch mounted to the vehicle for securing the base to the seat through the strap.

Previous ways of storing objects within a vehicle involved the use storage systems that rigidly connect to attachments located within a truck bed or on a roof of the vehicle. The embodiments described herein provide the storage module that secures objects within an interior of the vehicle to prevent the objects from shifting while the vehicle travels. The disposition of the base on the seat provides a rigid platform within in the interior upon which objects may be placed and secured.

Moreover, the coupler mounted to the strap provides a secure attachment to the latch, to maintain the position of the base on the seat. Furthermore, the disposition of the storage module within the interior of the vehicle provides theft protection, weather and climate protection, and accessibility to object while operating the vehicle. As the storage module is coupled to the vehicle seat by the coupler, the storage module allows a user to simply install the storage module when required. Further, the storage module can be easily removed by the use when no longer required. Various embodiments and benefits of the storage module will be described in more detail herein.

As used herein, the term “vehicle longitudinal direction” refers to the forward-rearward direction of the vehicle (i.e., in the +/- X direction of the coordinate axes depicted in FIG. 1). The term “vehicle lateral direction” refers to the cross-vehicle direction (i.e., in the +/- Y direction of the coordinate axes depicted in FIG. 1), and is transverse to the vehicle longitudinal direction. The term “vehicle vertical direction” refers to the upward-downward direction of the vehicle (i.e., in the +/- Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIG. 1, a vehicle 20 is provided with a storage module 22, in accordance with one or more embodiments of the present disclosure. The storage module 22 may be used in any configuration of a vehicle (e.g., a truck, pickup truck, passenger car, a van, a cargo van, a sport-utility vehicle, a crossover vehicle, airplane, boat, etc.) and may be used in any suitable location within the vehicle 20.

The storage module 22 is used for securing items within the vehicle 20, which may otherwise move within or be expelled from the vehicle 20 during operation of the vehicle 20. The vehicle 20 includes a chassis 24 that includes a floor 26. The chassis 24 may be further formed from one or more of a frame, a subframe, a monocoque, a unibody, a body-in-white, body panels, door(s), a trunk lid, a hood, etc. The chassis 24 provides a structure of the vehicle 20. The floor 26 partially defines a passenger compartment 28 of the vehicle 20.

The vehicle 20 may include a seat 30 coupled to the chassis 24. More specifically, the seat 30 may is fixed to the floor 26 within the passenger compartment 28 of the vehicle 20. The seat 30 is generally configured to support a passenger thereon during operation of the vehicle 20. The seat 30 may include a seat back cushion and a seat cushion. The seat back cushion is configured to extend upwardly from the seat cushion. The seat cushion is configured to support thighs of an occupant. The seat back cushion may be configured be rigidly secured to the seat cushion or pivotally coupled to the seat cushion to recline the seat cushion. The seat cushion may be configured to be rigidly secured to the chassis 24 or pivotally coupled to the seat back cushion as a tip-up seat cushion.

FIG. 1 shows that the vehicle 20 may further include a second seat 30A adjacent the seat 30 and a third seat 30B adjacent the second seat 30A. Like the seat 30, each of the second seat 30A and the third seat 30B are generally configured to support a passenger thereon during operation of the vehicle 20. In the embodiment shown in FIG. 1, the seat 30, the second seat 30A, and the third seat 30B are positioned in a bench configuration in the vehicle lateral direction Y across the vehicle 20, which may be found in a second row, third row, etc. of the vehicle 20. However, the seat 30, the second seat 30A, and/or the third seat 30B may be spaced from one another (e.g., a captain’s chair configuration) and may be positioned anywhere within the vehicle 20, including a first row. The vehicle 20 may only include the seat 30 and the second seat 30A which are configured as a 60/40 seat.

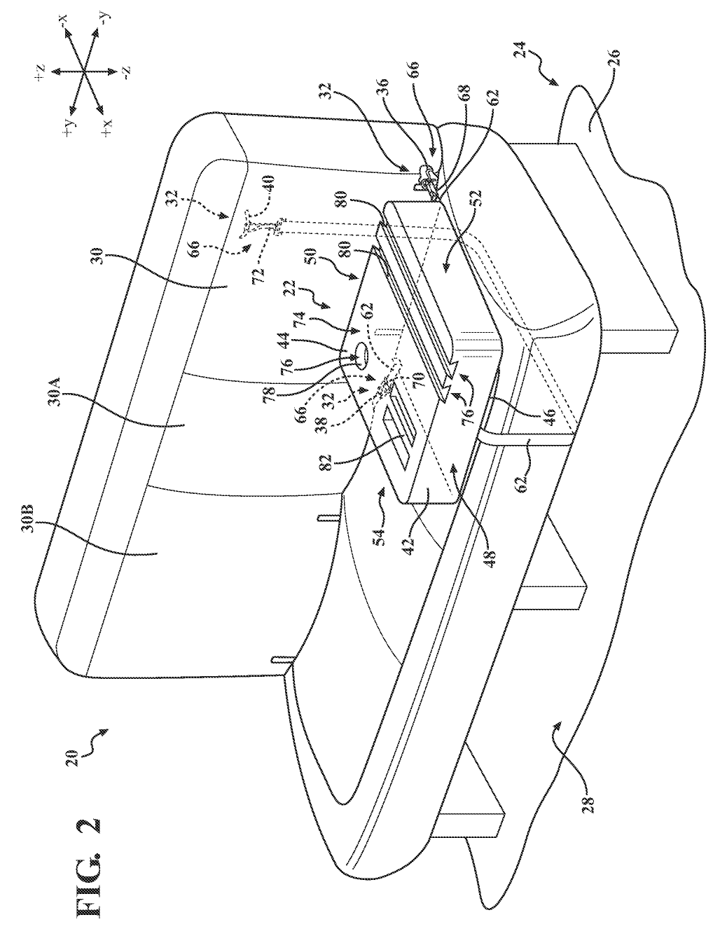

The vehicle 20 may include a plurality of latches 32 that are each coupled to the chassis 24. FIGS. 1 and 2, show various configurations of the plurality of latches 32, including a floor anchor 34 (FIG. 1), an Isofix anchor 36 (FIGS. 1 and 2), a seatbelt buckle 38 (FIG. 2), and a tether anchor 40 (FIG. 2). However, the plurality of latches 32 may include other components that the coupled to the chassis 24 either directly or indirectly. The floor anchor 34 may be directly coupled to the floor 26. The Isofix anchor 36, the seatbelt buckle 38, and the tether anchor 40 may be coupled to the seat 30, which is coupled to the floor 26 of the chassis 24. It is to be appreciated that the plurality of latches 32 may be coupled to the chassis 24 in other suitable ways not explicitly shown in the Figures(e.g., the seatbelt buckle 38 being directly coupled to the floor 26.)

The storage module 22 may include a base 42 configured to be disposed on the seat 30. The base 42 has an upper surface 44 and an opposite lower surface 46. When the storage module 22 is installed on the seat 30, the upper surface 44 faces upwardly in the vehicle vertical direction in a direction facing away from the seat cushion of the seat 30. As described in greater detail below, the upper surface 44 is configured to support an object thereon. When the storage module 22 is installed on the seat 30, the lower surface 46 faces downwardly in the vehicle vertical direction in a direction facing the seat cushion of the seat 30. The upper surface 44 of the base 42 has a horizontal orientation when disposed on the seat 30, which allows to the object to sit on and be supported by the base 42.

The base 42 has a planar configuration that extends in the vehicle longitudinal direction X and the vehicle lateral direction Y across the seat 30. In the vehicle longitudinal direction X, the base 42 includes a fore end 48 and an aft end 50, opposite the fore end 48. The fore end 48 may face a front of the vehicle 20 while the aft end 50 may face a rear of the vehicle 20. In the vehicle lateral direction Y, the base 42 includes a left end 52 and a right end 54, opposite the left end 52. As shown in FIGS. 1 and 2, the base 42 is configured as a rectangular prism. However, the base 42 may have any suitable shape and configuration.

In embodiments, the upper surface 44 may define an upper plane and the lower surface 46 defines a lower plane which extends generally parallel with the upper plane. In embodiments, the upper plane and the lower plane may be acutely angled such that the lower plane at the aft end 50 is spaced apart a first distance from the upper plane at the aft end 50, and the lower plane at the fore end 48 is spaced apart a second distance from the upper plane at the fore end 48 with the first distance being smaller than the second distance.

The base 42 may formed from a polymer that material that provides a rigid support structure for the object. The base 42 may also be formed from a metal, a composite, or any other material suitable for supporting the object.

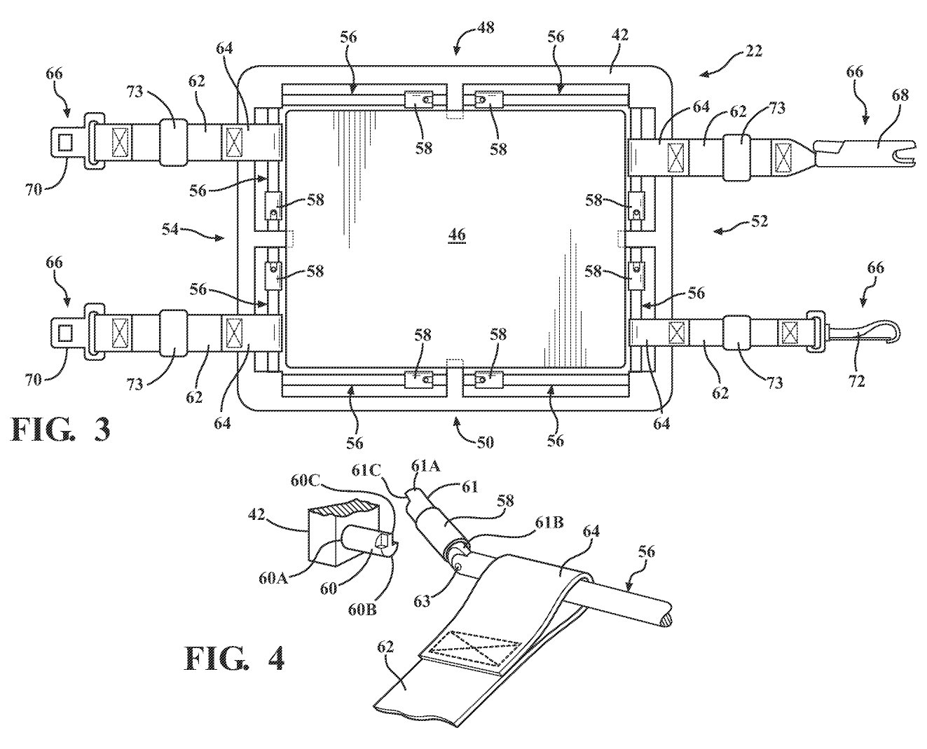

With reference to FIG. 3, the storage module 22 may include a plurality of rods 56 that are each fixed to the base 42. The plurality of rods 56 are disposed along the lower surface 46. More specifically, the plurality of rods 56 are recessed within the base 42 and disposed adjacent the lower surface 46. In the embodiment shown in FIG. 3, the plurality of rods 56 is formed from eight rods 56, with two of the rods 56 linearly aligned and extending along the fore end 48, with two of the rods 56 linearly aligned and extending along the aft end 50, with two of the rods 56 linearly aligned and extending along the left end 52, and with two of the rods 56 linearly aligned and extending along the right end 54. However, any number of rods 56 may be utilized and may be positioned in any suitable configuration relative to the base 42. Furthermore, each of the rods 56 may include a moveable cover 58, a fixed attachment portion 60, and a moveable attachment portion 61, as shown in FIG. 4 and described in greater detail below.

With reference to FIGS. 1-3, the storage module 22 may include a plurality of straps 62 that are each coupled to, and extend from, the base 42. More specifically, each of the plurality of straps 62 may be selectively mounted to any of the plurality of rods 56. As will be described in greater detail below, the extension of each of the plurality of straps 62 from the base 42 facilitates securement of the base 42 to the seat 30 and, moreover, the chassis 24.

For each of the plurality of straps 62, the strap 62 has a loop 64 configured wrap around the respective rod 56 and allow movement (e.g., sliding) of the strap 62 along the rod 56, as shown in FIGS. 3 and 4. As such, the plurality of straps 62 may be adjusted on the rods 56 to extend one or more directions that will allow the base 42 to be secured to the seat 30. The strap 62 may be formed of a strip of fabric, such as a nylon webbing typically used to form a seatbelt. The loop 64 may formed by folding the fabric on itself and sewing together the overlapping portion. In other embodiments, the loop 64 may be formed during the weaving of the fabric. In other embodiments, the loop 64 may be a separate component that is coupled to the fabric of the strap 62. Furthermore, it is to be appreciated that the strap 62 may be formed of any material that allows for securement of the base 42 to the seat 30.

As described above, each of the rods 56 may include the cover 58 that selectively covers the fixed attachment portion 60 and the moveable attachment portion 61, as shown in FIG. 4. The fixed attachment portion 60 has a fixed proximate end 60A fixed to the base 42 and an opposite distal end 60B. The moveable attachment portion 61 has a moveable distal end 61A and an opposite moveable proximate end 61B. The moveable proximate end 61B is hingedly coupled to the remainder of the rod 56 by a hinge 63. The cover 58, the fixed attachment portion 60, and the moveable attachment portion 61 allow an opening or breach to be formed in the rod 56 for the loop 64 of each of the plurality of the straps 62 to be installed or removed.

The cover 58 extends coaxial with the moveable attachment portion 61. The cover 58 is slidingly attached to the moveable attachment portion 61 and moveable between a retracted position and an extended position. The moveable attachment portion 61 is moveable between an open position and a closed position. The moveable attachment portion 61 is moveable to the open position when the cover 58 is in the retracted position. In the open position, the moveable distal end 61A is spaced part from the fixed distal end 60B by pivoting the movable attachment portion 61 about the hinge 63. As the moveable distal end 61A is spaced apart from the fixed distal end 60B, the loop 64 of each of the plurality of the straps 62 can be installed onto the rod 56 or removed from the rod 56. In the closed position, the moveable distal end 61A engages with the fixed distal end 60B to close the opening form in the rod 56 to retain the loop 64 of each of the plurality of the straps 62. In the extended position, the cover 58 covers the fixed distal end 60B and the moveable distal end 61A to inhibit movement of the movable attachment portion 61 with respect to the fixed attachment portion 60.

In embodiments, the fixed distal end 60B has a shaped configuration and the movable distal end 61A has a shaped configuration that corresponds to the shaped configuration of the fixed distal end 60B. In embodiments, the fixed distal end 60B includes a protrusion 60C and the movable distal end 61A includes a notch 61C configured to receive the protrusion 60C of the fixed distal end 60B.

As such, the plurality of straps 62 may selectively disposed on any of the rods 56. To prevent the plurality of straps 62 from the plurality of rods 56, each of the covers 58 in the closed position inhibit removal of the straps 62 from the rod 56.

With reference to FIGS. 1 and 2, the storage module 22 may include a plurality of the couplers 66. The plurality of couplers 66 are individually mounted to the plurality of straps 62 and configured to individually connect with the plurality of latches 32 that are mounted to the vehicle 20 for securing the base 42 to the seat 30 through the plurality of straps 62.

Any of the plurality of couplers 66 may comprise an Isofix buckle 68. As shown in FIG. 1, the Isofix buckle 68 may connect with the latch 32 of the vehicle 20 that is configured as the Isofix anchor 36. As also shown in FIG. 1, the Isofix buckle 68 may also connect with the latch 32 of the vehicle 20 that is configured as the floor anchor 34. Moreover, any of the plurality of couplers 66 may comprise a seatbelt tongue 70. As shown in FIG. 2, the seatbelt tongue 70 may connect with the latch 32 of the vehicle 20 that is configured as the seatbelt buckle 38. Furthermore, any of the plurality of couplers 66 may comprise a hook 72. As shown in FIG. 2, the hook 72 may connect with the latch 32 of the vehicle 20 that is configured as the tether anchor 40. It is to be appreciated that the plurality of couplers 66 may have other configurations that may connect with other latches not explicitly described herein.

Any number and configuration of the couplers 66 may be utilized. In one embodiment (shown in FIG. 1), the plurality of couplers 66 is formed from four couplers 66 that are each configured as the Isofix buckle 68. Furthermore, the plurality of latches 32 is formed from four latches 32, with two of the four latches 32 configured as the Isofix anchor 36 coupled to the seat 30 and with two of the four latches 32 configured as the floor anchor 34 coupled to the floor 26. Two of the four Isofix buckles 68 are individually connected to the two Isofix anchors 36 while two of the four Isofix buckles 68 are individually connected to the two floor anchors 34.

In another embodiment (shown in FIG. 2), the plurality of couplers 66 is formed from three couplers 66. One of the three couplers 66 is configured as the Isofix buckle 68, one of the three couplers 66 is configured as the seatbelt tongue 70, and one of the three couplers 66 is configured as the hook 72. Furthermore, the plurality of latches 32 is formed from three latches 32. One of the three latches 32 is configured as the Isofix anchor 36, with the Isofix buckle 68 connected to the Isofix anchor 36. One of the three latches 32 is configured as the seatbelt buckle 38, with the seatbelt tongue 70 connected to the seatbelt buckle 38. One of the three latches 32 is configured as the tether anchor 40, with the hook 72 connected to the tether anchor 40.

FIG. 3 shows another embodiment in which the plurality of couplers 66 is formed from four couplers 66. Two of the four couplers 66 are configured as the seatbelt tongue 70, one of the four couplers 66 is configured as the Isofix buckle 68, and one of the four couplers 66 is configured as the hook 72.

As described above, the plurality of straps 62 may be interchangeable on the plurality of rods 56. Therefore, the plurality of couplers 66 having the various configurations described above may be moved to various positions on the plurality of rods 56 to position the couplers 66 at locations along the base 42 that are suitable securing the base 42 to the seat 30.

With reference to FIGS. 1 and 2, each of the plurality of straps 62 may have a length between the base 42 and the respective coupler 66 coupled to the strap 62. The length of each of the plurality of straps 62 may be adjusted to tighten each of the straps 62 between the base 42 and the respective latch 32, which secures the base 42 to the seat 30. More specifically, the storage module 22 may include a plurality of cinches 73 individually coupled to plurality of straps 62, as shown in FIG. 3. The plurality of cinches 73 adjust the length of the respective straps 62 to secure the base 42 to the seat 30.

With reference to FIGS. 1 and 2, the storage module 22 may include an attachment interface 74 positioned along the upper surface 44 for securing the object to the base 42. The attachment interface 74 may include a void 76 extending into the base 42 from the upper surface 44.

The void 76 may comprise a hole 78 extending through the base 42, as shown in FIGS. 1 and 2. The hole 78 may be configured to receive the object therein and retain the object in at least the vehicle longitudinal direction X and the vehicle lateral direction Y. Alternatively, the hole 78 may receive a component that aides in securing the object to the base 42. For example, the hole 78 may receive a post that may be connected to the object or serve as a wall against which the object abuts. In yet another example, a ratchet strap, a bungee cord, a tiedown, etc. may engage the base 42 within the hole 78 to secure the object to the base 42. It is to be appreciated that the hole 78 may be utilized in any suitable manner to couple the object to the base 42. In embodiments, the hole 78 may extend between the upper surface 44 and the lower surface 46 of the base 42. In embodiments, the hole 78 may extend from the upper surface 44 at least partially through the base 42.

The void 76 may comprise a channel 80 extending longitudinally along the upper surface 44. The channel 80 may be configured to receive the object therein and retain the object. Alternatively, the channel 80 may receive a component that aides in securing the object to the base 42. For example, a wall maybe inserted into the channel 80, against which the object abuts. In yet another example, a component having a plurality of attachment points for a ratchet strap, a bungee cord, a tiedown, etc. may be coupled therein. In yet another example, the channel 80 may be configured to receive a rail therein (e.g., a picatinny rail) that may be connected to various other components and accessories. It is to be appreciated that the channel 80 may be utilized in any suitable manner to couple the object to the base 42.

The channel 80 is shown extending in the vehicle longitudinal direction X in FIGS. 1 and 2. However, the channel 80 may extend in the vehicle lateral direction Y or in a combination of the vehicle longitudinal direction X and the vehicle lateral direction Y. As shown in FIGS. 1 and 2, the attachment interface 74 may include a plurality of the void 76 (e.g., one hole 78 and two channels 80) each extending into the base 42 from the upper surface 44. It is to be appreciated that any number of holes 78 and any number channels 80 may be utilized. In embodiments, the channel 80 extends along the upper surface 44 from the aft end 50 to the fore end 48. In embodiments, the channel 80 extends along the upper surface 44 from the aft end 50 only partially through the base 42. In embodiments, the channel 80 extends along the upper surface 44 from the fore end 48 only partially through the base 42.

The attachment interface 74 may include a rail 82 mounted to the base 42. The rail 82 may serve as an attachment point for a component that secures the object to the base 42 (e.g., a ratchet strap, a bungee cord, a tiedown, etc.). In the embodiment shown in FIGS. 1 and 2, the rail 82 is integrally formed with the base 42. However, the rail 82 may be formed separately and mounted to the base 42. Moreover, in the embodiment shown in FIGS. 1 and 2, the rail 82 is flush with the upper surface 44 of the base 42 and is disposed in a recess defined by the base 42. However, the rail 82 may extend above the upper surface 44 in the vehicle vertical direction Z.

The rail 82 is shown extending in the vehicle longitudinal direction X in FIGS. 1 and 2. However, the rail 82 may extend in the vehicle lateral direction Y or in a combination of the vehicle longitudinal direction X and the vehicle lateral direction Y. Moreover, while one rail 82 is shown in FIGS. 1 and 2, any number of rails 82 may be utilized.

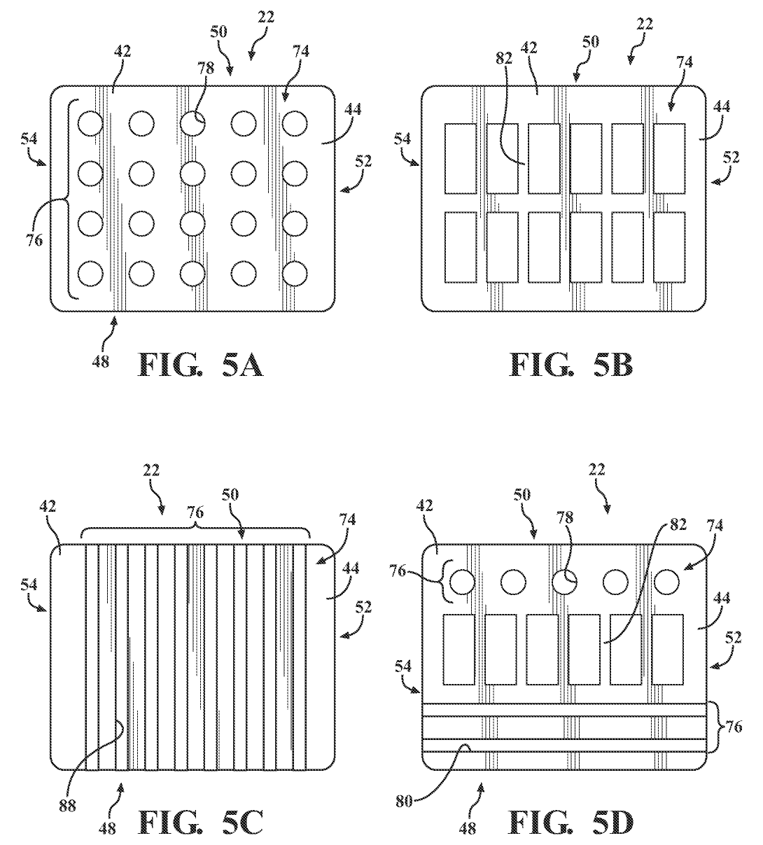

FIGS. 5A-5D show additional embodiments of the storage module 22, differentiated by variations in the attachment interface 74.

FIG. 5A shows an embodiment in which the attachment interface 74 includes the plurality of voids 76 disposed along the upper surface 44 in a grid configuration. All of the plurality of voids 76 are configured as the hole 78. The holes 78 are configured in five columns between the left end 52 and the right end 54 of the base 42 and in four rows between the fore end 48 and the aft end 50 of the base 42. As such, the attachment interface 74 includes twenty holes 78.

FIG. 5B shows an embodiment in which the attachment interface 74 includes the plurality of rails 82. The rails 82 are configured in five columns between the left end 52 and the right end 54 of the base 42 and in two rows between the fore end 48 and the aft end 50 of the base 42. As such, the attachment interface 74 includes ten rails 82.

FIG. 5C shows an embodiment in which the attachment interface 74 includes the plurality of voids 76. All of the plurality of voids 76 are configured as the channel 80. The plurality of channels 80 includes eight channels 80 extending between the fore end 48 and the aft end 50 and evenly spaced from one another across the base 42 between the left end 52 to the right end 54.

FIG. 5D shows an embodiment in which the attachment interface 74 includes the plurality of holes 78, the plurality of channels 80, and the plurality of rails 82. The plurality of rails 82 are disposed toward the fore end 48 of the base 42, the plurality of holes 78 are disposed toward the aft end 50 of the base 42, and the plurality of rails 82 are disposed between the plurality of channels 80 and the plurality of holes 78. The plurality of channels 80 includes two channels 80 extending between the left end 52 and the right end 54 are evenly spaced from one another across the base 42 between the fore end 48 and the aft end 50. The plurality of rails 82 includes five rails 82 arranged in a single row of five columns that are evenly spaced from one another between the left end 52 and the right end 54. The plurality of holes 78 includes five holes 78 arranged in a single row of five columns that are evenly spaced from one another between the left end 52 and the right end 54.

The fore end 48 of the base 42 may be configured to extend off the seat 30, as shown in FIG. 7. By extending to the fore end 48 off the seat 30, the base 42 the surface area of the upper surface 44 may be increased in comparison to the embodiments described above. The increase in surface area of the upper surface 44 allow for storage of more and/or larger objects.

The storage module 22 further include a leg 84 mounted to the lower surface 46 of the base 42 adjacent the fore end 48 and extending to the floor 26 of the vehicle 20 to support the base 42. The leg 84 includes an upper end 100 and an opposite lower end 102. The leg 84 is pivotally coupled to the lower surface 46 of the base 42 by a hinge 104. In embodiments, the leg 84 includes a link 106 having one end pivotally coupled to the lower surface 46 of the base 42 and an opposite end 110 pivotally coupled to the leg 84 at a position between the upper end 100 and the lower end 102. The leg 84 is moveable between a use position, as shown in FIG. 7, and a stowed position. The link 106 provides a brace for the leg 84 when in the use position.

In the use position, the leg 84 extend generally in the vehicle vertical direction with the lower end 102 abutting the floor 26 and provides additional support for the portion of the base 42 that extend off the seat 30. In the stowed position, the leg 84 is folded so as to extend from the fore end 48 towards the aft end 50, as shown in broken lines in FIG. 7. In the stowed position, the leg 84 is stored within the base 42 while not in use.

As shown in FIG. 7, the lower end 102 of the leg 84 may include a coupler 66 formed as the Isofix buckle 68. The floor 26 may include the floor anchor 34 such that when the leg 84 is in the use position the Isofix buckle 68 engages with the floor anchor 34. The engagement of the Isofix buckle 68 of the leg 84 with the floor anchor 34 provides additional support for the portion of the base 42 that extend off the seat 30.

In other embodiments, the leg 84 may include a boot at the lower end 102, in place of the Isofix buckle 68 when the floor anchor 34 is not provide in the floor 26 at the location of the lower end 102 of the leg 84 when the leg 84 is in the use position. The boot may have a friction surface at a bottom end that engages with the floor 26 to prevent movement of the leg 84 when the leg is in the use position.

In other embodiments, the leg 84 may detachable coupled to the base 42. When installed, the leg 84 provides the additional support for the base 42. When the leg 84 is detached, the leg 84 may be stored separate from the base 42 to aide in storage. In embodiments, the leg 84 may be extendable. The leg 84 may be formed of a plurality of telescoping coaxial rods that extend or retract to accommodate variations in a distance between the seat 30 and the floor 26 between various vehicles.

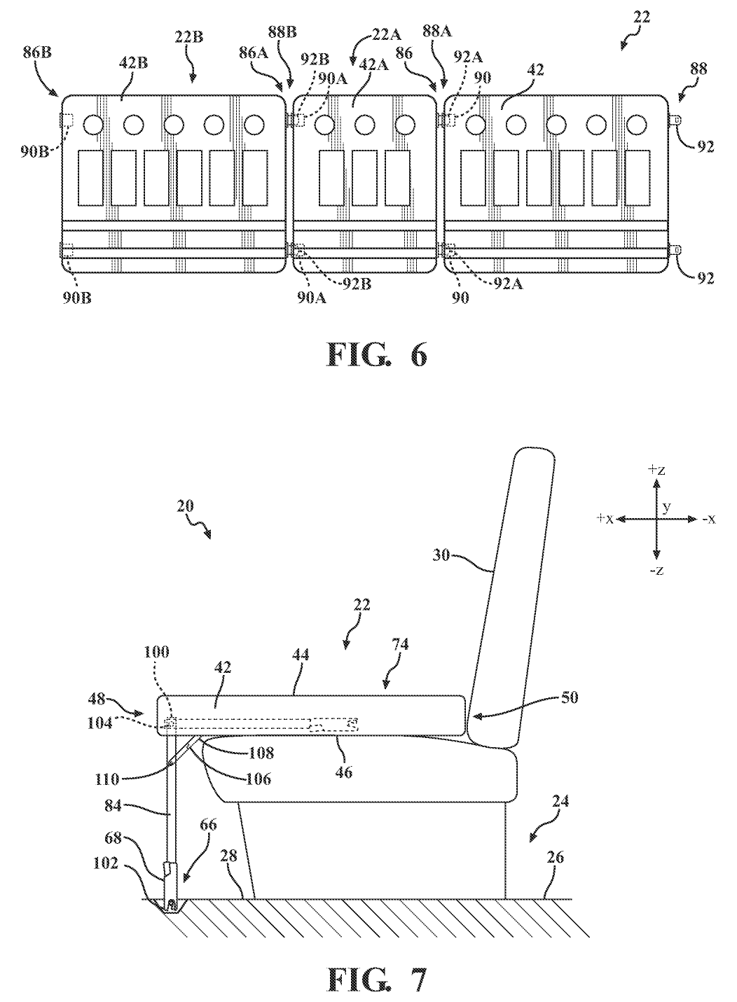

As described above, the vehicle 20 may include the second seat 30A adjacent the seat 30. Accordingly, the vehicle 20 may further include a second storage module 22A. The second storage module 22A may include any of the components of the storage module 22 described above. For purposes of the discussion below, the second storage module 22A includes a base 42A shown in FIG. 6. The base 42A of the second storage module 22A is similar to the base 42 of the storage module 22. The base 42A of the second storage module 22A may be disposed on the second seat 30A, adjacent the base 42 of the storage module 22 disposed on the seat 30.

With reference to FIG. 6, the storage module 22 may comprise a first connector 86 mounted to the base 42 of the storage module 22 and the second storage module 22A may comprise a second connector 88A mounted to the base 42A of the second storage module 22A. The first connector 86 and the second connector 88A are configured to couple for interconnecting the storage module 22 with the second storage module 22A. In doing so, the storage module 22 and the second storage module 22A are secured to one another, allowing their coupling to the plurality of latches 32 to be collectively utilized.

As shown in FIG. 6, the first connector 86 includes a plurality of receptacles 90 and the second connector 88A includes a plurality of posts 92A that individually engage the plurality of receptacles 90 to interconnect the storage module 22 with the second storage module 22A. However, the first connector 86 and the second connector 88A may have any suitable configuration for interconnecting the storage module 22 with the second storage module 22A. Moreover, the storage module 22 may have a second connector 88 including a plurality of posts 92, similar to the second connector 88A and the plurality of posts 92A of the second storage module 22A. Likewise, the second storage module 22A may have a first connector 86A including a plurality of receptacles 90A, similar to the first connector 86 and the plurality of receptacles 90 of the storage module 22. Therefore, the storage module 22 and the second storage module 22A may be interchangeably placed on the seat 30 and the second seat 30A.

As described above, the vehicle 20 may include the third seat 30B adjacent the second seat 30A. Accordingly, the vehicle 20 may further include a third storage module 22B. The third storage module 22B may include any of the components of the storage module 22 described above. For purposes of the discussion below, the third storage module 22B includes a base 42B shown in FIG. 6. The base 42B of the third storage module 22B is similar to the base 42 of the storage module 22. The base 42B of the third storage module 22B may be disposed on the third seat 30B, adjacent the base 42A of the second storage module 22A disposed on the second seat 30A.

With reference to FIG. 6, the third storage module 22B may comprise both a first connector 86B and a second connector 88B mounted to the base 42B of the third storage module 22B. The first connector 86B may include a plurality of receptacles 90B and the second connector 88B may include a plurality of posts 92B. The first connector 86B and the plurality of receptacles 90B and the second connector 88B and the plurality of posts 92B of the third storage module 22B are similar to the first connector 86 and the plurality of receptacles 90A and the second connector 88 and the plurality of posts 92 of the storage module 22. The second connector 88B of the third storage module 22B may couple with the first connector 86A of the second storage module 22A (as shown in FIG. 6) for interconnecting the second storage module 22A with the third storage module 22B. In doing so, the second storage module 22A and the third storage module 22B are secured to one another, allowing their coupling to the plurality of latches 32 to be collectively utilized. Moreover, the storage module 22, the second storage module 22A, and the third storage module 22B may be secured to one another as showing in FIG. 6, allowing their coupling to the plurality of latches 32 to be collectively utilized. The storage module 22, the second storage module 22A, and the third storage module 22B may be interchangeably placed on the seat 30, the second seat 30A, and the third seat 30B.

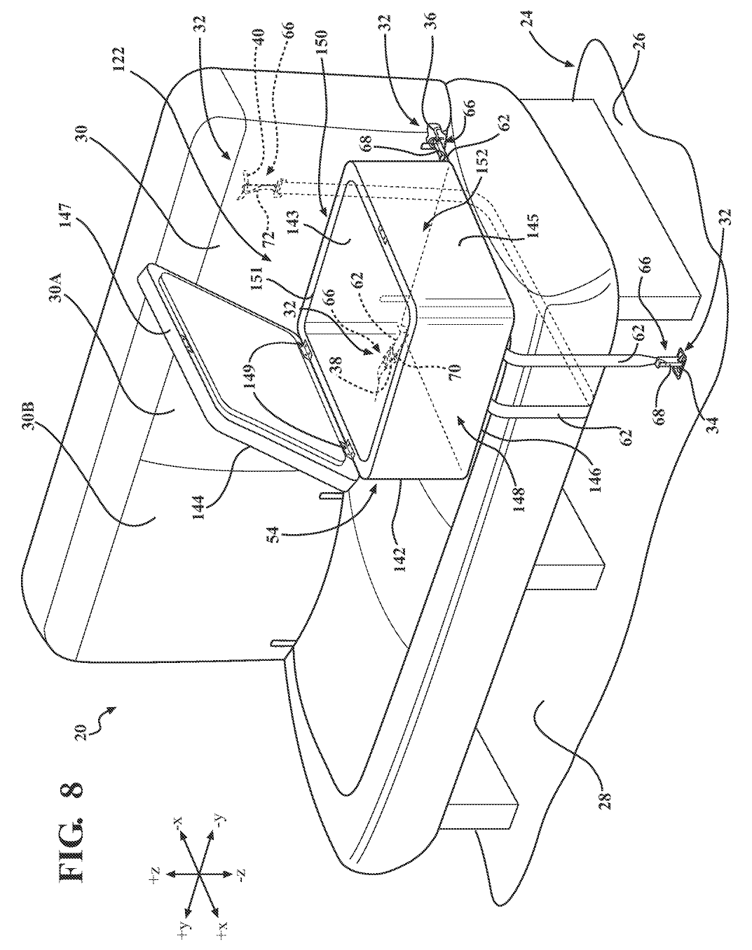

With reference to FIG. 8, a storage module 122 is shown that includes a receptacle 142 configured to be disposed on the seat 30. The storage module 122 of FIG. 8 is equivalent to the one or more embodiments of the storage module 42 described above and shown FIGS. 1-7, but for the use of the receptacle 142 in place of the base 42. Therefore, the characteristics and features of the storage module 22 described herein are directly applicable to the storage module 122.

The receptacle 142 has an upper surface 144 and an opposite lower surface 146. When the storage module 122 is installed on the seat 30, the upper surface 144 faces upwardly in the vehicle vertical direction Z in a direction facing away from the seat cushion of the seat 30. As described in greater detail below, the upper surface 144 is configured to support an object thereon. When the storage module 122 is installed on the seat 30, the lower surface 146 faces downwardly in the vehicle vertical direction in a direction facing the seat cushion of the seat 30.

The receptacle 142 extends in the vehicle longitudinal direction X and the vehicle lateral direction Y across the seat 30. In the vehicle longitudinal direction X, the receptacle 142 includes a fore end 148 and an aft end 150, opposite the fore end 148. The fore end 148 may face a front of the vehicle 20 while the aft end 150 may face a rear of the vehicle 20. In the vehicle lateral direction Y, the receptacle 142 includes a left end 152 and a right end 154, opposite the left end 152. In the embodiment shown in FIG. 1, the receptacle 142 is configured as a rectangular prism. However, the receptacle 142 may have any suitable shape and configuration.

The receptacle 142 may define an interior 143 for disposing the object therein. With the object disposed within the interior 143, the object confined to the volume defined by the interior 143. The receptacle 142 may include a first section 145 partially defining the interior 143 and an aperture 151 opening into the interior 143. The receptacle 142 may further include a second section 147 covering the aperture 151 in a closed position and spaced from the aperture 151 in an open position to allow access to the interior 143 through the aperture 151. More specifically, the lower surface 146 is disposed along the first section 145 of the receptacle 142 and the upper surface 144 is disposed along the second section 147 of the receptacle 142. The aperture 151 opens upwardly in the vehicle vertical direction Z such that an operator may place the object within the interior 143 by lowering the object into the interior 43.

In the embodiment shown in FIG. 8, the receptacle 142 includes a plurality of hinges 149 disposed between the first section 145 and the second section 147 along the right end, which allows the second section 147 to pivot relative to the first section 145 between the open position and the closed position. However, the first section 145 and the second section 147 may be configured to slide, rotate, articulate, or otherwise move relative to one another in any suitable manner between the open position and the closed position. Furthermore, the second section 147 may fully disconnect from the first section 45 in the open position such that the second section 147 may be removed.

In another embodiment, the receptacle 142 may be configured as a basket (e.g., similar to the embodiment shown in FIG. 8, but without the second section 147). In yet another embodiment, the receptacle 142 may have drawers that slidably open and close to dispose objects within the interior 143. In yet another embodiment, the receptacle 142 may include a door disposed on a side of the receptacle 142 that pivots to open and close the interior 143. It is to be appreciated that the receptacle 142 may have any suitable configuration for accessing and placing the object within the interior 143.

In some embodiments, the interior 143 of the receptacle 142 may refrigerated for storage of temperature sensitive objects therein (e.g., food). More specifically, the receptacle 142 may include a refrigeration unit that is electrically powered by the vehicle or a battery to cool the interior 143 of the receptacle 142.

The receptacle 142 may formed from a polymer that material that provides a rigid support structure for the object. The receptacle 142 may also be formed from a metal, a composite, or any other material suitable for supporting the object. The receptacle 142 may be also include an insulation layer to reduce heat transfer between the interior 143 and the exterior of the receptacle 142. The insulation layer may include fiberglass batting, polymer foam, etc.

It should now be understood that embodiments of the present disclosure are directed to a storage module for a vehicle. The storage module may include a base configured to be disposed on a seat of the vehicle. The base may have an upper surface facing away from the seat and configured to support an object thereon. The storage module may include an attachment interface positioned along the upper surface for securing the object to the base and a strap coupled to, and extending from, the base. The storage module may include a coupler mounted to the strap. The coupler may be configured to connect with a latch mounted to the vehicle for securing the base to the seat through the strap. The disposition of the base on the seat provides a rigid platform within in the interior upon which objects may be placed and secured. Moreover, the coupler mounted to the strap provides a secure attachment to the latch, which rigidly maintains the position of the base on the seat. Furthermore, the disposition of the storage module within the interior of the vehicle provides theft protection, weather and climate protection, and accessibility to object while operating the vehicle.

It is noted that the terms "substantially," “generally,” and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A storage module for a vehicle, the storage module comprising:
a base configured to be disposed on a seat of the vehicle, the base having an upper surface facing away from the seat and configured to support an object thereon;
an attachment interface positioned along the upper surface for securing the object to the base;
a strap coupled to, and extending from, the base; and
a coupler mounted to the strap, the coupler configured to connect with a latch mounted to the vehicle for securing the base to the seat through the strap.

2. The storage module of claim 1, wherein the attachment interface includes a void extending into the base from the upper surface.

3. The storage module of claim 2, wherein the void comprises a hole extending through the base.

4. The storage module of claim 2, wherein the void comprises a channel extending longitudinally along the upper surface.

5. The storage module of claim 2, further comprising a plurality of the void each extending into the base from the upper surface, the plurality of voids disposed along the upper surface in a grid configuration.

6. The storage module of claim 1, wherein the attachment interface includes a rail mounted to the base.

7. The storage module of claim 1, wherein the base includes a fore end and an aft end, opposite the fore end, and a lower surface disposed opposite the upper surface, the fore end configured to extend off the seat, the storage module further comprising a leg mounted to the lower surface of the base adjacent the fore end and configured to extend to a floor of the vehicle to support the base.

8. The storage module of claim 1, wherein the coupler comprises a seatbelt tongue configured to connect with the latch of the vehicle comprising a seatbelt buckle.

9. The storage module of claim 1, wherein the coupler comprises an Isofix buckle configured to connect with the latch of the vehicle comprising an Isofix anchor.

10. The storage module of claim 1, wherein the coupler comprises a hook configured to connect with the latch of the vehicle comprising a tether.

11. A vehicle comprising:
a chassis;
a seat coupled to the chassis;
a latch coupled to the chassis; and
a storage module comprising:
a base disposed on the seat, the base having an upper surface facing away from the seat and configured to support an object thereon;
an attachment interface positioned along the upper surface for securing the object to the base;
a strap coupled to, and extending from, the base; and
a coupler mounted to the strap and configured to connect with the latch for securing the base to the seat through the strap.

12. The vehicle of claim 11, wherein the upper surface of the base has a horizontal orientation when disposed on the seat.

13. The vehicle of claim 11, wherein the base has a planar configuration that extends in a vehicle longitudinal direction and a vehicle lateral direction across the seat.

14. The vehicle of claim 11, further comprising a plurality of the latch that are each coupled to the chassis, the storage module further comprising:
a plurality of the strap that are each coupled to, and extending from, the base; and
a plurality of the coupler individually mounted to the plurality of straps and configured to individually connect with the plurality of latches for securing the base to the seat through the plurality of straps.

15. The vehicle of claim 11, wherein the base of the storage module includes a fore end and an aft end, opposite the fore end, and a lower surface disposed opposite the upper surface, the fore end extending off the seat, the storage module further comprising a leg mounted to the lower surface of the base adjacent the fore end and extending to a floor of the vehicle to support the base.

16. The vehicle of claim 11, further comprising:
a second seat adjacent the seat; and
a second storage module comprising a base disposed on the second seat,
wherein the storage module comprises a first connector mounted to the base of the storage module and the second storage module comprises a second connector mounted to the base of the second storage module, the first connector and the second connector configured to couple for interconnecting the storage module with the second storage module.

17. A storage module for a vehicle, the storage module comprising:
a base configured to be disposed on a seat of the vehicle, the base having an upper surface facing away from the seat and configured to support an object thereon;
an attachment interface positioned along the upper surface for securing the object to the base;
a rod fixed to the base; and
a strap mounted to the rod and configured to secure the base to the seat.

18. The storage module of claim 17, further comprising a coupler mounted to the strap, the coupler configured to connect with a latch mounted to the vehicle for securing the base to the seat through the strap.

19. The storage module of claim 17, wherein the strap has a loop wrapped around the rod and allowing movement of the strap along the rod.

20. The storage module of claim 17, further comprising a plurality of the rod that are each fixed to the base, the strap configured to be selectively mounted to any of the plurality of rods.
